(19) United States
(12) Patent Application Publication
(10) Pub. No.: US 2016/0299265 A1
(43) Pub. Date: Oct. 13, 2016

(54) METHODS FOR FABRICATING OPTICAL LENSES

(71) Applicant: INDIAN INSTITUTE OF TECHNOLOGY KANPUR, Uttar Pradesh (IN)

(72) Inventors: Animangsu GHATAK, Kanpur, Uttar Pradesh (IN); Abhijit Chandra ROY, Kanpur, Uttar Pradesh (IN)

(73) Assignee: INDIAN INSTITUTE OF TECHNOLOGY KANPUR, Uttar Pradesh (IN)

(21) Appl. No.: 15/100,328

(22) PCT Filed: Nov. 17, 2014
(86) PCT No.: PCT/IB2014/066090

§ 371 Date: May 30, 2016

(30) Foreign Application Priority Data
Nov. 29, 2013 (IN) 3473/DEL/2013

(51) Int. Cl. G02B 3/14; B29D 11/00; G02B 3/04; G02B 1/06; G02B 3/00; G02B 3/06

(52) U.S. Cl. CPC G02B 3/14; G02B 3/005; G02B 3/0031; G02B 3/06; G02B 3/04; G02B 1/06; B29D 11/00009; B29D 11/00855; B29D 11/00634; B29K 2083/00

(57) ABSTRACT

Methods of forming a tunable focal length lens and an optical filter are disclosed. The tunable focal length lens may have varying focal lengths due to liquids within micro-channels which may cause varying cross-sectional areas of the micro-channels. The tunable focal length lens may have variable force. The tunable focal length lens may have a variable refractive index. The optical filter may have varying wavelengths due to dyes within the micro-channels. An apparatus incorporating an aspherical lens is also disclosed.

### BACKGROUND

Cylindrical lenses are used in a variety of engineering applications, such as, laser scanning, laser diodes, acousto-optics, optical processor applications, and optical beam splitting apparatus. Optical aberrations in simple cylindrical lenses can be problematic for these applications. The use of an aspherical cylindrical lens can reduce the optical aberrations. Aspherical lenses designed and fabricated on soft platforms are often preferred for a variety of applications because of their improved performance. Current processes for the design and fabrication of aspherical lenses are time-consuming, expensive, and are not suitable for the generation of aspherical lenses on soft platforms. There is a demand for an improved design and fabrication of aspherical lenses, especially on soft platforms.

### SUMMARY

Presently disclosed is a method of forming a tunable focal length lens. The method may include forming at least one micro-channel in a polymer matrix, adding a first liquid to the micro-channel, wherein the first liquid may cause a first change in a cross-sectional area of the micro-channel, and wherein the first change may form a first lens of a first focal length, and replacing the first liquid in the micro-channel with a second liquid, wherein the second liquid may cause a second change in the cross-sectional area of the micro-channel, and wherein the second change may form a second lens of a second focal length different from the first focal length.

In some embodiments, a method of forming a tunable focal length lens may include forming at least one micro-channel in a polymer matrix, adding a first liquid to the micro-channel, wherein the first liquid may cause a cross-sectional change of the at least one micro-channel, and wherein the cross-sectional change of the at least one micro-channel may form a lens of a first focal length with an aspherical bulge, bonding the lens to a flexible substrate, fixing the flexible substrate along with the lens between two rigid spacers, and applying a first force to the flexible substrate to cause a first change in the first focal length of the lens.

In some embodiments, a method of forming a tunable focal length lens may include forming at least one micro-channel in a polymer matrix, adding a first liquid to the micro-channel, wherein the first liquid may cause a cross-sectional change of the micro-channel, and wherein the cross-sectional change of the micro-channel may form a lens with an aspherical bulge, pouring a pre-polymer composition, wherein the crosslinking may form a fixed aspherical bulge, and replacing the first liquid with a second liquid, wherein the second liquid has a different refractive index than the first liquid.

In some embodiments, a method of forming an optical filter may include forming at least one micro-channel in a polymer matrix, adding a first liquid to the micro-channel, wherein the first liquid may cause a cross-sectional change of the micro-channel, and wherein the cross-sectional change of the micro-channel may form a lens of a first focal length with an aspherical bulge, pouring a pre-polymer composition on the aspherical bulge, crosslinking the pre-polymer composition, wherein the crosslinking may form a fixed aspherical bulge, and adding first dye to the micro-channel, wherein the first dye may cause the lens to be wavelength selective.

In an embodiment, an apparatus may include a reservoir, wherein the reservoir may be configured to store at least one liquid, a device coupled to the reservoir, wherein the device may be configured to transfer the at least one liquid from the reservoir, and a plate with a plurality of micro-channels coupled to the device, wherein the plurality of micro-channels may be configured to receive the at least one liquid from the device, wherein the plurality of micro-channels may be configured to form at least one lens.

### BRIEF DESCRIPTION OF THE FIGURES

FIG. 1 depicts a flowchart of an illustrative method of forming a tunable focal length lens.

FIG. 2 depicts a flowchart of an illustrative method of forming a tunable focal length lens with variable force according to an embodiment.

FIG. 3 depicts a flowchart of an illustrative method of forming a tunable focal length lens with a variable refractive index according to an embodiment.

FIG. 4 depicts a flowchart of an illustrative method of making an optical filter.

FIG. 5 depicts an apparatus with a plurality of aspherical lenses according to an embodiment.

FIG. 6 depicts four plots of intensity of transmitted light through four aspherical lenses.

FIG. 7 depicts a plot of focal length versus thickness for two aspherical lenses.

FIG. 8 depicts an aspherical lens with applied stress according to an embodiment.

FIG. 9 depicts a plot of refractive index versus different percentage of calcium chloride solutions in water and a plot of focal length versus refractive index.

### DETAILED DESCRIPTION

The technologies described in this document are not limited to the particular systems, methodologies or protocols described, as these may vary. The terminology used herein is for the purpose of describing particular embodiments only, and is not intended to limit the scope of the present disclosure.

It must be noted that as used herein and in the appended claims, the singular forms “a,” “an,” and “the” include plural reference unless the context clearly dictates otherwise. Unless defined otherwise, all technical and scientific terms used herein have the same meanings as commonly understood by one of ordinary skill in the art. As used herein, the term “comprising” means “including, but not limited to.”

The following terms shall have, for the purposes of this application, the respective meanings set forth below.

A “micro-channel” refers to any small cylindrical-like hollow structure. For example, a micro-channel has a diameter of less than 5 millimeters and is able to be filled with a liquid.

A “flexible substrate” refers to any non-rigid material that is used as a plate. A “plate” refers to any flat material that is used as a base. Typically, a flexible substrate is able to be manipulated, while also supporting any substance requiring a base for reinforcement.

A “bulge” refers to any protrusion of an otherwise flat surface of a liquid or a solid. For example, a bulge of the micro-channel creates a curvature of the micro-channel which is used as a lens.

A “natural dye” refers to any dye or colorant that is derived from nature and is not man-made. Examples of natural dyes include lichens, henna, alkanet, dyer's bugloss, sagebrush, red onion skins, woad, and dyer's knotweed.

A “reservoir” refers to any container that stores a substance for later use. A reservoir is used when filling is required for adding a liquid to a plurality of micro-channels according to an embodiment.

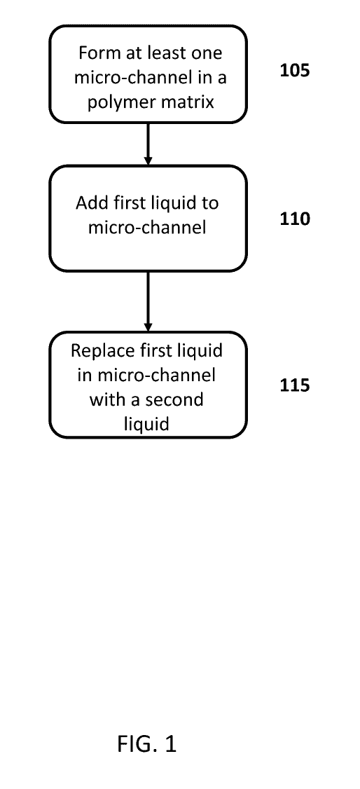

FIG. 1 depicts a flowchart of an illustrative method of forming a tunable focal length lens. In some embodiments, the focal length may be spatially tunable. The lens may be a single lens, a plurality of lenses, an array of lenses, or hierarchical lenses. In some embodiments, the lens may have a topographically patterned surface. In other embodiments, the lens may have a chemically heterogeneous surface.

In some embodiments the lens may have generally any thickness, such as an average thickness of about 15 micrometers to about 85 micrometers. For example, the average thickness may be about 15 micrometers, about 20 micrometers, about 25 micrometers, about 30 micrometers, about 35 micrometers, about 40 micrometers, about 45 micrometers, about 50 micrometers, about 55 micrometers, about 60 micrometers, about 65 micrometers, about 70 micrometers, about 75 micrometers, about 80 micrometers, about 85 micrometers, or a range between any of these values (including endpoints).

In some embodiments, the lens may have a first focal length of generally any length, such as about 0.25 millimeters to about 0.65 millimeters. For example, the focal length may be about 0.25 millimeters, about 0.30 millimeters, about 0.35 millimeters, about 0.40 millimeters, about 0.45 millimeters, about 0.50 millimeters, about 0.55 millimeters, about 0.60 millimeters, about 0.65 millimeters, or a range between any of these values (including endpoints).

At least one micro-channel may be formed 105 in a polymer matrix. The micro-channel may have an average diameter of generally any diameter, such as about 0.45 millimeters to about 1.2 millimeters. For example, the average diameter may be about 0.45 millimeters, about 0.5 millimeters, about 0.6 millimeters, about 0.7 millimeters, about 0.8 millimeters, about 0.9 millimeters, about 1.0 millimeters, about 1.1 millimeters, about 1.2 millimeters, or a range between any of these values (including endpoints). In some embodiments, the polymer matrix may include a plurality of micro-channels.

The polymer matrix may be a silicone, a polyurethane, a thermoplastic elastomer, a fluoroelastomer, a copolyester elastomer, a chlorosulfonated polyethylene, a neoprene, an ethyl vinyl acetate, a polysulfate, a polycarbonate, an acrylate polymer, a siloxane-based polymer, a co-polymer thereof, or a combination thereof. In some embodiments, the polymer matrix may be polydimethylsiloxane.

A first liquid may be added 110 to the micro-channel. In some embodiments, the first liquid may cause a first change in a cross-sectional area of the micro-channel. The first change may form a lens of a first focal length. In some embodiments, the first change may be caused by wetting the polymer. The first liquid may have a viscosity of generally any amount, such as about 100 centipoise to about 1000 centipoise. For example, the first liquid may have a viscosity of about 100 centipoise, about 200 centipoise, about 300 centipoise, about 400 centipoise, about 500 centipoise, about 600 centipoise, about 700 centipoise, about 800 centipoise, about 900 centipoise, about 1000 centipoise, or a range between any of these values (including endpoints). In some embodiments, the first liquid may be water, a silicone oil, glycerol, a paraffinic oil, a naphthenic oil, an aromatic oil, castor oil, or a combination thereof.

The first liquid may be replaced 115 in the micro-channel with a second liquid. In some embodiments, the second liquid may cause a second change in the cross-sectional area of the micro-channel. The second change may form a second lens of a second focal length different from the first focal length. In some embodiments, the second change may be caused by wetting the polymer. The second liquid may have a viscosity of generally any amount, such as about 100 centipoise to about 1000 centipoise. For example, the second liquid may have a viscosity of about 100 centipoise, about 200 centipoise, about 300 centipoise, about 400 centipoise, about 500 centipoise, about 600 centipoise, about 700 centipoise, about 800 centipoise, about 900 centipoise, about 1000 centipoise, or a range between any of these values (including endpoints). In some embodiments, the second liquid may have a higher viscosity than the first liquid. In other embodiments, the second liquid may have a lower viscosity than the first liquid. In some embodiments, the second liquid may be water, a silicone oil, glycerol, a paraffinic oil, a naphthenic oil, an aromatic oil, castor oil, or a combination thereof.

In some embodiments the second lens may have generally any thickness, such as an average thickness of about 15 micrometers to about 85 micrometers. For example, the average thickness may be about 15 micrometers, about 20 micrometers, about 25 micrometers, about 30 micrometers, about 35 micrometers, about 40 micrometers, about 45 micrometers, about 50 micrometers, about 55 micrometers, about 60 micrometers, about 65 micrometers, about 70 micrometers, about 75 micrometers, about 80 micrometers, about 85 micrometers, or a range between any of these values (including endpoints).

The method may additionally include replacing the second liquid with a third liquid. In some embodiments, the third liquid may cause a third change in the cross-sectional area of the micro-channel. The third change may form a third lens of a third focal length different from the first focal length and second focal length. In some embodiments, the third change may be caused by wetting the polymer. The third liquid may have a viscosity of generally any amount, such as about 100 centipoise to about 1000 centipoise. For example, the third liquid may have a viscosity of about 100 centipoise, about 200 centipoise, about 300 centipoise, about 400 centipoise, about 500 centipoise, about 600 centipoise, about 700 centipoise, about 800 centipoise, about 900 centipoise, about 1000 centipoise, or a range between any of these values (including endpoints). In some embodiments, the third liquid may have a higher viscosity than the first liquid. In other embodiments, the third liquid may have a lower viscosity than the first liquid. In some embodiments, the third liquid may be water, a silicone oil, glycerol, a paraffinic oil, a naphthenic oil, an aromatic oil, castor oil, or a combination thereof.

In some embodiments, the lens may be bonded to a rigid substrate. In other embodiments, the lens may be bonded to a flexible substrate. The flexible substrate may be a flat surface or a curved surface. The flexible substrate may be glass, ceramic, quartz, fiberglass, polystyrene, polycarbonate, resin, or a combination thereof. In some embodiments, the flexible substrate may be coated with silane functionalized molecules before forming the at least one micro-channel in the polymer matrix. In other embodiments, the flexible substrate may be oxidized with plasma before forming the at least one micro-channel in the polymer matrix.

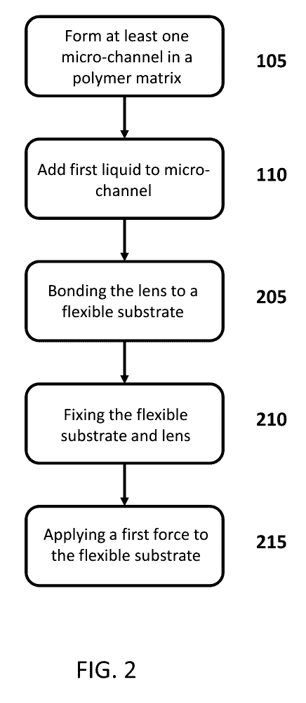

FIG. 2 depicts a flowchart of an illustrative method of forming a tunable focal length lens with variable force according to an embodiment. In some embodiments, the focal length may be spatially tunable. The lens may be a single lens, a plurality of lenses, an array of lenses, or hierarchical lenses. In some embodiments, the lens may have a topographically patterned surface. In other embodiments, the lens may have a chemically heterogeneous surface.

In some embodiments the lens may have generally any thickness, such as an average thickness of about 15 micrometers to about 85 micrometers. For example, the average thickness may be about 15 micrometers, about 20 micrometers, about 25 micrometers, about 30 micrometers, about 35 micrometers, about 40 micrometers, about 45 micrometers, about 50 micrometers, about 55 micrometers, about 60 micrometers, about 65 micrometers, about 70 micrometers, about 75 micrometers, about 80 micrometers, about 85 micrometers, or a range between any of these values (including endpoints).

In some embodiments, the lens may have a first focal length of generally any length, such as about 0.25 millimeters to about 0.65 millimeters. For example, the focal length may be about 0.25 millimeters, about 0.30 millimeters, about 0.35 millimeters, about 0.40 millimeters, about 0.45 millimeters, about 0.50 millimeters, about 0.55 millimeters, about 0.60 millimeters, about 0.65 millimeters, or a range between any of these values (including endpoints).

The operation of forming 105 at least one micro-channel in a polymer matrix in FIG. 2 may be substantially similar to the operation of forming 105 at least one micro-channel in a polymer matrix as described in FIG. 1. The operation of adding 110 a first liquid to the at least one micro-channel in FIG. 2 may be substantially similar to the operation of adding 110 a first liquid to the at least one micro-channel as described in FIG. 1. In some embodiments, the cross-sectional change of the micro-channel may form a lens of a first focal length with an aspherical bulge.

In some embodiments, the lens may be bonded 205 to a flexible substrate. In other embodiments, the lens may be bonded 205 to a rigid substrate. The flexible substrate may be a flat surface or a curved surface. The flexible substrate may be glass, ceramic, quartz, fiberglass, polystyrene, polycarbonate, resin, or a combination thereof. In some embodiments, the flexible substrate may be coated with silane functionalized molecules before forming the at least one micro-channel in the polymer matrix. In other embodiments, the flexible substrate may be oxidized with plasma before forming the at least one micro-channel in the polymer matrix.

In some embodiments, the flexible substrate may be fixed 210 along with the lens between two rigid spacers. In some embodiments, the at least one micro-channel formed 105 in the polymer matrix may have a vertical space separating the at least one micro-channel from the flexible substrate due to the two rigid spacers. The rigid spacers may have generally any height, such as about 5 micrometers to about 120 micrometers. For example, the height may be about 5 micrometers, about 10 micrometers, about 15 micrometers, about 20 micrometers, about 25 micrometers, about 30 micrometers, about 35 micrometers, about 40 micrometers, about 45 micrometers, about 50 micrometers, about 55 micrometers, about 60 micrometers, about 65 micrometers, about 70 micrometers, about 75 micrometers, about 80 micrometers, about 85 micrometers, about 90 micrometers, about 95 micrometers, about 100 micrometers, about 105 micrometers, about 110 micrometers, about 115 micrometers, about 120 micrometers, or a range between any of these values (including endpoints).

In some embodiments, a first force may be applied 215 to the flexible substrate that may cause a first change in the first focal length of the lens. In other embodiments, a second force may be applied to the flexible substrate that may cause a second change in the first focal length. The second change in the first focal length may be different from the first change in the first focal length.

In some embodiments, stress may be applied to the polymer matrix after forming the at least one micro-channel in the polymer matrix. In some embodiments, the stress may be uniaxial extensional stress. In other embodiments, the stress may be biaxial extensional stress. In some embodiments, the stress may be an extension of generally any amount, such as about 1% to about 50%. For example, the stress may be an extension of about 1%, about 5%, about 10%, about 15%, about 20%, about 25%, about 30%, about 35%, about 40%, about 45%, about 50%, or a range between any of these values (including endpoints). The applied stress may vary the focal length of the lens, spatial variation of the lens, or magnification index of the lens.

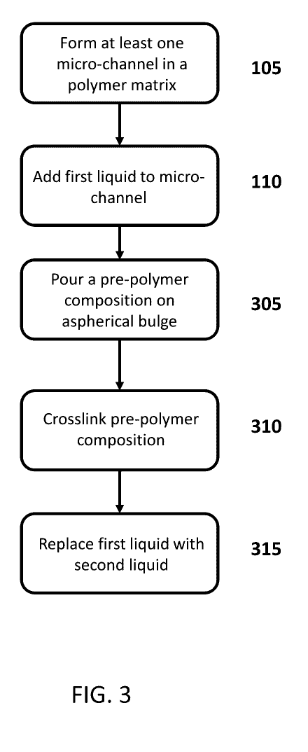

FIG. 3 depicts a flowchart of an illustrative method of forming a tunable focal length lens with variable refractive index according to an embodiment. In some embodiments, the focal length may be spatially tunable. The lens may be a single lens, a plurality of lenses, an array of lenses, or hierarchical lenses. In some embodiments, the lens may have a topographically patterned surface. In other embodiments, the lens may have a chemically heterogeneous surface.

In some embodiments the lens may have generally any thickness, such as an average thickness of about 15 micrometers to about 85 micrometers. For example, the average thickness may be about 15 micrometers, about 20 micrometers, about 25 micrometers, about 30 micrometers, about 35 micrometers, about 40 micrometers, about 45 micrometers, about 55 micrometers, about 60 micrometers, about 65 micrometers, about 70 micrometers, about 75 micrometers, about 80 micrometers, about 85 micrometers, or a range between any of these values (including endpoints).

In some embodiments, the lens may have a first focal length of generally any length, such as about 0.25 millimeters to about 0.65 millimeters. For example, the focal length may be about 0.25 millimeters, about 0.30 millimeters, about 0.35 millimeters, about 0.40 millimeters, about 0.45 millimeters, about 0.50 millimeters, about 0.55 millimeters, about 0.60 millimeters, about 0.65 millimeters, or a range between any of these values (including endpoints).

The operation of forming 105 at least one micro-channel in a polymer matrix in FIG. 3 may be substantially similar to the operation of forming 105 at least one micro-channel in a polymer matrix as described in FIG. 1. The operation of adding 110 a first liquid to the at least one micro-channel in FIG. 3 may be substantially similar to the operation of adding 110 a first liquid to the at least one micro-channel as described in FIG. 1. In some embodiments, the cross-sectional change of the micro-channel may form a lens of a first focal length with an aspherical bulge.

In some embodiments, a pre-polymer composition may be poured 305 on the aspherical bulge. The pre-polymer composition may be a pre-polymer liquid and a crosslinking agent. The pre-polymer liquid may be a silicone, a polyurethane, a thermoplastic elastomer, a fluoroelastomer, a copolyester elastomer, a chlorosulfonated polyethylene, a neoprene, an ethyl vinyl acetate, a polysulfate, a polycarbonate, an acrylate polymer, a siloxane-based polymer, a co-polymer thereof, or a combination thereof. In some embodiments, the pre-polymer liquid may be polydimethylsiloxane.

In some embodiments, the pre-polymer liquid may be mixed with a crosslinking agent. The crosslinking agent may be generally any curing agent. For example, the crosslinking agent may be a curing agent for Sylgard 184 elastomer.

In some embodiments, the pre-polymer composition may be crosslinked 310. The crosslinking 310 of the pre-polymer composition may form a fixed aspherical bulge. The crosslinking 310 may form an optically smooth flat film with the fixed aspherical bulge embedded inside the crosslinked 310 pre-polymer composition. The fixed aspherical bulge may allow the liquid inside the at least one micro-channel to be replaced without causing any change to the geometry of the lens.

In some embodiments, the first liquid may be replaced 315 with a second liquid. The second liquid may have a viscosity of generally any amount, such as about 100 centipoise to about 1000 centipoise. For example, the second liquid may have a viscosity of about 100 centipoise, about 200 centipoise, about 300 centipoise, about 400 centipoise, about 500 centipoise, about 600 centipoise, about 700 centipoise, about 800 centipoise, about 900 centipoise, about 1000 centipoise, or a range between any of these values (including endpoints). In some embodiments, the second liquid may have a higher viscosity than the first liquid. In other embodiments, the second liquid may have a lower viscosity than the first liquid. In some embodiments, the second liquid may be water, a silicone oil, glycerol, a paraffinic oil, a naphthenic oil, an aromatic oil, castor oil, or a combination thereof.

In some embodiments, the second liquid may have a different refractive index than the first liquid. The refractive index of the second liquid may be about 1.33 to about 1.52. For example, the refractive index of the second liquid may be about 1.33, about 1.35, about 1.37, about 1.39, about 1.41, about 1.43, about 1.45, about 1.47, about 1.49, about 1.51, about 1.52, or a range between any of these values (including endpoints).

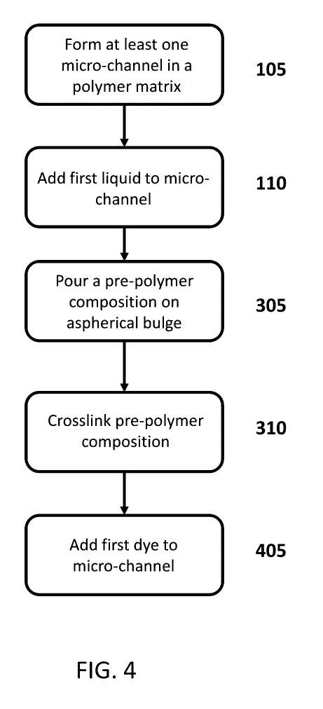

FIG. 4 depicts a flowchart of an illustrative method of making an optical filter. In an embodiment, the optical filter may be wavelength selective. The optical filter may also be used as a wavelength concentrator.

In some embodiments the optical filter may have a lens with an average thickness of generally any amount, such as about 15 micrometers to about 85 micrometers. For example, the average thickness may be about 15 micrometers, about 20 micrometers, about 25 micrometers, about 30 micrometers, about 35 micrometers, about 40 micrometers, about 45 micrometers, about 55 micrometers, about 60 micrometers, about 65 micrometers, about 70 micrometers, about 75 micrometers, about 80 micrometers, about 85 micrometers, or a range between any of these values (including endpoints).

The operation of forming 105 at least one micro-channel in a polymer matrix in FIG. 4 may be substantially similar to the operation of forming 105 at least one micro-channel in a polymer matrix as described in FIG. 1. The operation of adding 110 a first liquid to the at least one micro-channel in FIG. 4 may be also substantially similar to the operation of adding 110 a first liquid to the at least one micro-channel as described in FIG. 1. In some embodiments, the cross-sectional change of the micro-channel may form a lens of a first focal length with an aspherical bulge.

The operation of pouring 305 a pre-polymer composition on the aspherical bulge in FIG. 4 may be substantially similar to the operation of pouring 305 a pre-polymer composition on the aspherical bulge in FIG. 3. The operation of crosslinking 310 the pre-polymer composition in FIG. 4 may be substantially similar to the operation of crosslinking 310 the pre-polymer composition in FIG. 3.

In some embodiments, the optical filter may select wavelengths of about 450 nanometers to about 495 nanometers. In other embodiments, the wavelength selective lens may select wavelengths of about 495 nanometers to about 570 nanometers. In further embodiments, the wavelength selective lens may select wavelengths of about 590 nanometers to about 750 nanometers. For example, the wavelengths may be about 450 nanometers, about 475 nanometers, about 495 nanometers, about 500 nanometers, about 525 nanometers, about 550 nanometers, about 570 nanometers, about 590 nanometers, about 600 nanometers, about 625 nanometers, about 650 nanometers, about 675 nanometers, about 700 nanometers, about 725 nanometers, about 750 nanometers, or a range between any of these values (including endpoints).

In some embodiments, a first dye may be added 405 to the micro-channel. In some embodiments, the first dye may cause the lens to be wavelength selective. The first liquid may be added 110 to the micro-channel and the first dye may be added 405 to the micro-channel simultaneously. In some embodiments, the first dye may be reversibly replaced with a second dye in the micro-channel.

In some embodiments, the first dye may be a red dye. The red dye may be Rhodamine 6G, Methyl Red, Haematoxylin, Acid Red 87, D&C Red Number 22, Reactive Red 180, Direct Red 81, Basic Red 18, Basic Red 76, natural dyes, artificial dyes, or a combination thereof.

In some embodiments, the first dye may be a green dye. The green dye may be Brilliant green, Malachite green, Fast Green FCF, Green S, natural dyes, artificial dyes, or a combination thereof.

In other embodiments, the first dye may be a blue dye. The blue dye may be Cotton Blue, Brilliant Blue, Crystal Violet, Methylene Blue, Acid Blue 9, Direct Blue 199, Disperse Blue 165, natural dyes, artificial dyes, or a combination thereof.

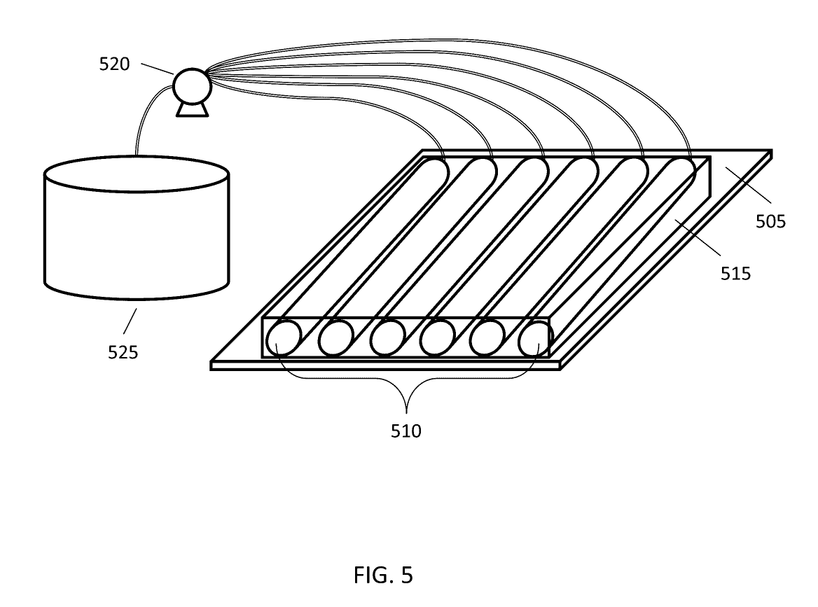

FIG. 5 depicts an apparatus with a plurality of aspherical lenses according to an embodiment. In an embodiment, the apparatus may include a reservoir 525, wherein the reservoir 525 may be configured to store at least one liquid, a device 520 coupled to the reservoir 525, wherein the device 520 may be configured to deliver the at least one liquid from the reservoir 525, a plate 505 with a plurality of micro-channels 510 coupled to the device 520, wherein the plurality of micro-channels 510 may be configured to receive the at least one liquid from the device 520, wherein the plurality of micro-channels 510 may be configured to form at least one lens.

In some embodiments, the reservoir 525 may be configured to store the at least one liquid. In an embodiment, the reservoir 525 may be coupled to the device 520 with at least one tube. The reservoir 525 may be of a particular shape or volume, such as a cube, a cuboid, a square-based pyramid, a triangular-based pyramid, a triangular prism, a hexagonal prism, a cone, a sphere, a cylinder, or any combination thereof. The reservoir 525 may have generally any volume, such as about 0.1 milliliter to about 5 milliliters. For example, the reservoir may have a volume of about 0.1 milliliter, about 0.2 milliliter, about 0.5 milliliter, about 1 milliliter, about 2 milliliters, about 3 milliliters, about 4 milliliters, about 5 milliliters, or a range between any of these values (including endpoints). The reservoir 525 may have multiple compartments. The multiple compartments may store multiple liquids. In some embodiments, each compartment may have a different volume. In some embodiments, at least one compartment may have a different volume from at least one other compartment.

In some embodiments, the at least one liquid may be water, a silicone oil, glycerol, a paraffinic oil, a naphthenic oil, an aromatic oil, castor oil, or a combination thereof. In some embodiments, the at least one liquid may have a viscosity of generally any amount, such as about 100 centipoise to about 1000 centipoise. For example, the at least one liquid may have a viscosity of about 100 centipoise, about 200 centipoise, about 300 centipoise, about 400 centipoise, about 500 centipoise, about 600 centipoise, about 700 centipoise, about 800 centipoise, about 900 centipoise, about 1000 centipoise, or a range between any of these values (including endpoints).

In some embodiments, the device 520 may be configured to transfer the at least one liquid from the reservoir 525 to the plate 505 including a plurality of micro-channels 510. The device 520 may be coupled to the plate 505 with at least one tube. In some embodiments, the device 520 may be a pump or a valve. For example, the device 520 may be a syringe pump, a peristaltic pump, a piston pump, or a micropump.

In an embodiment, a template may be placed into a polymer matrix 515 positioned on the plate 505. The template may be a straight cylindrical rod. The template may create one or more micro-channels 510 within the polymer matrix 515. The template may be removed from the polymer matrix 515 by any suitable method. For example, the template may be removed by exerting a small force which releases the template from the polymer matrix 515. At least one micro-channel 510 may be formed in the polymer matrix 515 where the template was positioned before removal. The micro-channel 510 may be positioned within the polymer matrix 515 using spacers. The spacers may be used to create a vertical space between the plate 505 and the micro-channel.

The spacers may have generally any height, such as a height of about 5 micrometers to about 120 micrometers. For example, the height may be about 5 micrometers, about 10 micrometers, about 15 micrometers, about 20 micrometers, about 25 micrometers, about 30 micrometers, about 35 micrometers, about 40 micrometers, about 45 micrometers, about 50 micrometers, about 55 micrometers, about 60 micrometers, about 65 micrometers, about 70 micrometers, about 75 micrometers, about 80 micrometers, about 85 micrometers, about 90 micrometers, about 95 micrometers, about 100 micrometers, about 105 micrometers, about 110 micrometers, about 115 micrometers, about 120 micrometers, or a range between any of these values (including endpoints).

The plurality of micro-channels 510 may have an average diameter of generally any amount, such as about 0.45 millimeters to about 1.2 millimeters. For example, the average diameter may be about 0.45 millimeters, about 0.5 millimeters, about 0.6 millimeters, about 0.7 millimeters, about 0.8 millimeters, about 0.9 millimeters, about 1.0 millimeters, about 1.1 millimeters, about 1.2 millimeters, or a range between any of these values (including endpoints).

In some embodiments, the plurality of micro-channels 510 may be configured to form at least one lens. The plurality of micro-channels 510 may be positioned at different vertical distances from the top surface of the polymer matrix 515. Spacers may be used to position the plurality of micro-channels 510 from the top surface of the polymer matrix 515. The top surface of the polymer matrix 515 is located opposite the bottom surface of the polymer matrix 515 which contacts the plate 505. The plurality of micro-channels 510 may be positioned at generally any vertical distance, such as about 5 micrometers to about 120 micrometers. For example, the vertical distance may be about 5 micrometers, about 10 micrometers, about 20 micrometers, about 30 micrometers, about 40 micrometers, about 50 micrometers, about 60 micrometers, about 70 micrometers, about 80 micrometers, about 90 micrometers, about 100 micrometers, about 110 micrometers, about 120 micrometers, or a range between any of these values (including endpoints).

The plurality of micro-channels 510 may be silicone, a polyurethane, a thermoplastic elastomer, a fluoroelastomer, a copolyester elastomer, a chlorosulfonated polyethylene, a neoprene, an ethyl vinyl acetate, a polysulfate, a polycarbonate, an acrylate polymer, a siloxane-based polymer, or a co-polymer thereof. The plurality of micro-channels 310 may be polydimethylsiloxane.

In some embodiments, the plate 505 may be a rigid substrate. In other embodiments, the plate 505 may be a flexible substrate. In some embodiments, the polymer matrix 515 may be bonded to the plate 505. In other embodiments, the polymer matrix 515 may not be bonded to the plate 505. The plate 505 may be glass, ceramic, quartz, fiberglass, polystyrene, polycarbonate, resin, or a combination thereof. In some embodiments, the plate 505 may be glass.

In some embodiments, the at least one lens may have an average thickness of generally any amount, such as about 15 micrometers to about 85 micrometers. For example, the average thickness may be about 15 micrometers, about 20 micrometers, about 25 micrometers, about 30 micrometers, about 35 micrometers, about 40 micrometers, about 45 micrometers, about 55 micrometers, about 60 micrometers, about 65 micrometers, about 70 micrometers, about 75 micrometers, about 80 micrometers, about 85 micrometers, or a range between any of these values (including endpoints).

In some embodiments, the at least one lens may have a focal length of generally any length, such as about 0.25 millimeters to about 0.65 millimeters. For example, the focal length may be about 0.25 millimeters, about 0.30 millimeters, about 0.35 millimeters, about 0.40 millimeters, about 0.45 millimeters, about 0.50 millimeters, about 0.55 millimeters, about 0.60 millimeters, about 0.65 millimeters, or a range between any of these values (including endpoints).

### EXAMPLES

### Example 1

### Preparing a Tunable Focal Length Optical Lens

A soft polydimethylsiloxane layer was bonded to a microscope glass slide. The polydimethylsiloxane had a shear modulus of 1.0 MPa. The soft polydimethylsiloxane layer was embedded with four micro-channels having a diameter of 450 μm and a vertical height from the glass slide of 0 μm. One micro-channel was filled with silicone oil with a viscosity of 374 cP and a surface tension of 21 mN/m. The remaining three micro-channels were not filled with liquid. A thin skin of the top layer of the surface of the polydimethylsiloxane over the embedded micro-channel bulged out after wetting of the polydimethylsiloxane with the silicone oil. The top surface had an aspherical bulge which appeared convex cylindrical, but with spatially varying curvature. The thin layer above the aspherical bulge on the top surface was an optical lens. When light was transmitted through the aspherical bulge, the light became concentrated.

### Example 2

### Preparing an Array of Tunable Focal Length Lenses

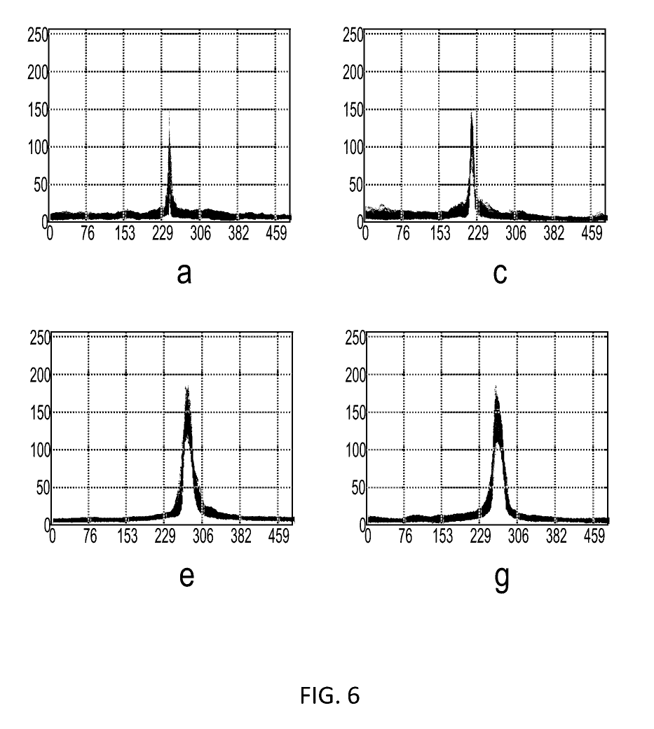

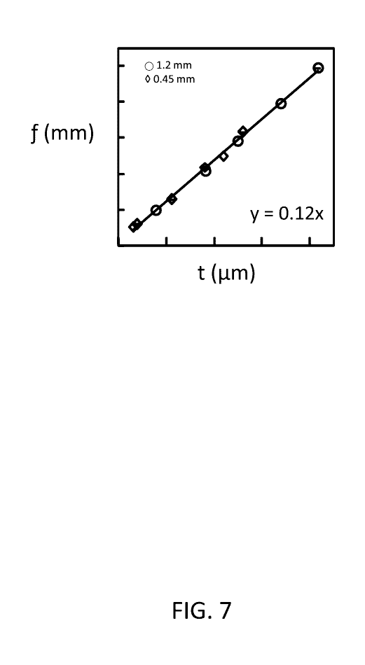

A soft polydimethylsiloxane layer was bonded to a microscope glass slide. The polydimethylsiloxane had a shear modulus of 1.0 MPa. The soft polydimethylsiloxane layer was embedded with four micro-channels having a diameter of 1.2 mm and a vertical height from the glass slide of 68 μm, 48 μm, 16 μm, and 0 μm for channels 1, 2, 3, and 4, respectively. Spacers of different heights equal to that of the desired vertical height from the glass substrate were used during the preparation of channels. All four micro-channels were filled with silicone oil with a viscosity of 374 cP and a surface tension of 21 mN/m. A thin skin of the top layer of the surface of the polydimethylsiloxane over the embedded micro-channels bulged out after wetting of the polydimethylsiloxane with the silicone oil. The top surface of each micro-channel had an aspherical bulge. The effect of the bulging of polydimethylsiloxane layers in each micro-channel resulted in varying skin thicknesses of 16 m, 36 μm, 68 μm, and 84 μm for channels 1, 2, 3, and 4, respectively. These layers were used as lenses for focusing light. The graphs as seen in FIG. 6(a), FIG. 6(c), FIG. 6(e), and FIG. 6(g) show the spatial variation in intensity of the transmitted light for which the skin thickness was varied as 16, 36, 68, and 84 μm, respectively. FIG. 6(e) shows that the maximum intensity was achieved at a skin thickness of 68 μm. FIG. 7 shows how the focal length, f, of the lenses vary with the thickness, t, of the thin skin on the top surface of the micro-channel. Symbols, ◯ and ⋄ represent two different lenses, where the diameters of the embedded micro-channels are 1.2 mm and 0.45 mm, respectively.

### Example 3

### Using a Tunable Focal Length Lenses with Applied Stress

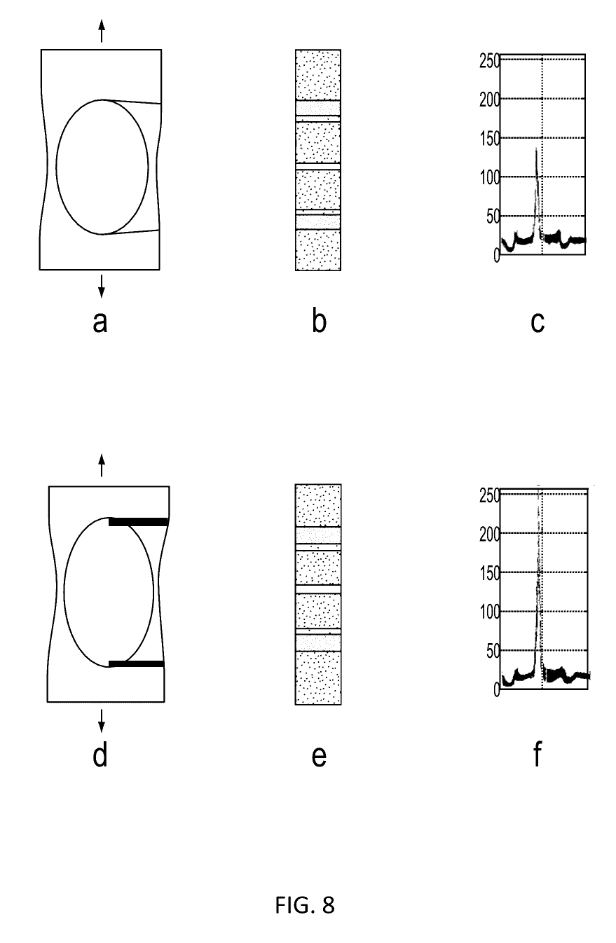

A soft freestanding polydimethylsiloxane layer was prepared. The polydimethylsiloxane had a shear modulus of 1.0 MPa. The soft polydimethylsiloxane layer was embedded with a micro-channel having a diameter of 450 μm and a vertical height of 30 μm (skin thickness) of the soft polydimethylsiloxane layer on the top and bottom surface of the micro-channel. The micro-channel was filled with silicone oil with a viscosity of 374 cP and a surface tension of 21 mN/m. Uniaxial extensional stress was applied to the micro-channel. A thin skin of the top layer of the surface of the polydimethylsiloxane over the embedded micro-channel bulged out after wetting of the polydimethylsiloxane with the silicone oil. The top surface of the micro-channel had an aspherical bulge. This layer was used as a lens for focusing light. The lens was bonded to a microscope glass slide. The images as shown in FIG. 8 (a-c) and (d-f) show uniaxial extension of 10% and 20%, respectively. These images show that both focal length and magnification of lenses were reversibly altered by varying the extension ratio of the skin thickness on the top surface of the micro-channel.

### Example 4

### Preparing a Tunable Focal Length Lenses with Different Refractive Indices

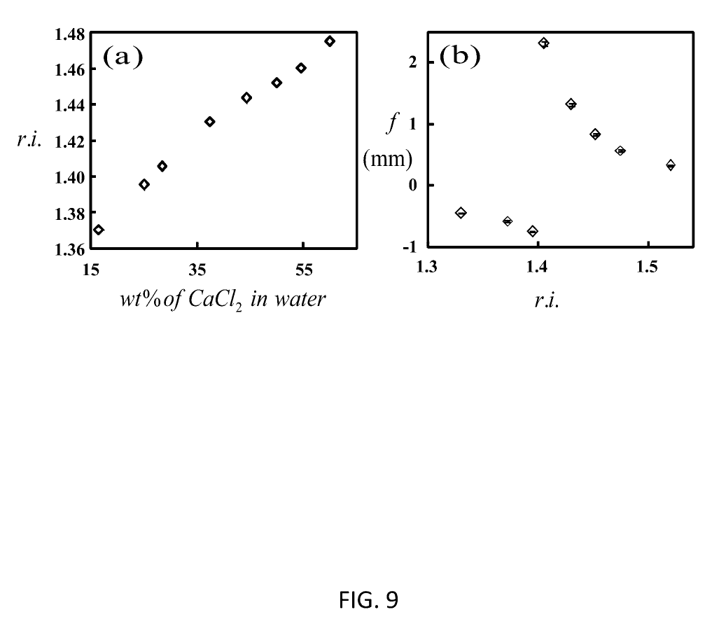

A soft polydimethylsiloxane layer was prepared. The polydimethylsiloxane had a shear modulus of 1.0 MPa. The soft polydimethylsiloxane layer was embedded with a micro-channel having a diameter of 1200 μm and a vertical height of 84 μm (skin thickness) of the soft polydimethylsiloxane layer. The micro-channel was filled with silicone oil with a viscosity of 374 cP. A thin skin of the top layer of the surface of the polydimethylsiloxane over the embedded micro-channel bulged out resulting in an aspherical cylindrical lens. The bulged aspherical lens was fixed by crosslinking a layer of additional polydimethylsiloxane over the bulging lens such that the top surface of the additional polydimethylsiloxane layer remained smooth and flat and the resulting skin thickness became 115 μm. The liquid inside the micro-channel was then removed without causing any alteration of the size and shape of the micro-channel cross-section. The lenses were filled with different calcium chloride solutions in water. The liquids varied from 15 wt % to 60 wt % of calcium chloride in water. The refractive index varied from 1.333 to 1.47. For a refractive index less than 1.4, the lens behaved as a concave lens. For a refractive index greater than 1.4, the lens behaved as a convex lens. A refractive index of 1.52 was achieved when the liquid was a microscope emersion oil and not a calcium chloride solution. FIG. 9(a) shows the plot variation of the refractive index (r.i.) of the different calcium chloride solutions in water. FIG. 9(b) shows a typical plot of focal length, f, versus the refractive index of the cylindrical lens.

### Example 5

### Preparing an Optical Filter

A soft polydimethylsiloxane layer was prepared. The polydimethylsiloxane had a shear modulus of 1.0 MPa. The soft polydimethylsiloxane layer was embedded with a micro-channel having a diameter of 1200 m and a vertical height of 40 μm (skin thickness) of the soft polydimethylsiloxane layer. The micro-channel was filled with silicone oil with a viscosity of 374 cP. The thin skin of the micro-channel bulged out resulting in an aspherical cylindrical lens. The bulged aspherical cylindrical lens was fixed by crosslinking an additional layer of polydimethylsiloxane over the bulging lens such that the top surface of the additional layer of polydimethylsiloxane remained smooth and flat. The liquid inside the micro-channel was then removed without causing any alteration of the size and shape of the micro-channel cross-section. The micro-channel was then filled with a solution of Eosin in water. A focused line of red light was formed due to the combined effect of lensing and filtering by the micro-channel filled with the Eosin solution. A second micro-channel of same diameter, but without the aspherical geometry was used as a control. When the second micro-channel was filled with the same Eosin solution, only the filtering effect resulted, but no focusing of the light occurred.

This disclosure is not limited to the particular systems, devices and methods described, as these may vary. The terminology used in the description is for the purpose of describing the particular versions or embodiments only, and is not intended to limit the scope.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to”, the term “having” should be interpreted as “having at least”, the term “includes” should be interpreted as “includes but is not limited to”, etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations”, without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A method of forming a tunable focal length lens, the method comprising:
forming at least one micro-channel in a polymer matrix;
adding a first liquid to the micro-channel, wherein the first liquid causes a first change in a cross-sectional area of the micro-channel, and wherein the first change forms a first lens of a first focal length; and
replacing the first liquid in the micro-channel with a second liquid, wherein the second liquid causes a second change in the cross-sectional area of the micro-channel, and wherein the second change forms a second lens of a second focal length different from the first focal length.

2.-3. (canceled)

4. The method of claim 1, further comprising replacing the second liquid with a third liquid, wherein the third liquid causes a third change in the cross-sectional area of the micro-channel, and wherein the third change forms a third lens of a third focal length different from the first focal length and the second focal length.

5. (canceled)

6. The method of claim 1, wherein the forming comprises forming the micro-channel having an average diameter of about 0.45 millimeters to about 1.2 millimeters.

7. (canceled)

8. The method of claim 1, wherein one or more of forming the first lens and forming the second lens comprises forming a first lens and a second lens having an average thickness of about 15 micrometers to about 85 micrometers.

9. (canceled)

10. The method of claim 1, further comprising bonding the first lens to a flexible substrate.

11. The method of claim 10, wherein the bonding comprises bonding to glass, ceramic, quartz, fiberglass, polystyrene, polycarbonate, resin, or a combination thereof.

12. The method of claim 10, further comprising one or more of coating the flexible substrate with silane functionalized molecules and oxidizing the flexible substrate with plasma before forming the at least one micro-channel in the polymer matrix.

13. (canceled)

14. The method of claim 1, wherein the forming comprises forming in a silicone, a polyurethane, a thermoplastic elastomer, a fluoroelastomer, a copolyester elastomer, a chlorosulfonated polyethylene, a neoprene, an ethyl vinyl acetate, a polysulfate, a polycarbonate, an acrylate polymer, a siloxane-based polymer, or a co-polymer thereof.

15. The method of claim 1, wherein the forming comprises forming in polydimethylsiloxane.

16. The method of claim 1, wherein the adding comprises adding water, a silicone oil, glycerol, a paraffinic oil, a naphthenic oil, an aromatic oil, castor oil, or a combination thereof.

17. The method of claim 1, wherein the adding forms a first lens having a first focal length of about 0.25 millimeters to about 0.65 millimeters.

18. The method of claim 1, wherein the adding comprises adding the first liquid having a viscosity of about 100 centipoise to about 1000 centipoise.

19. The method of claim 1, wherein the replacing comprises replacing with the second liquid having a viscosity of about 100 centipoise to about 1000 centipoise.

20. The method of claim 1, wherein the replacing comprises replacing with the second liquid having a higher viscosity than the first liquid.

21. The method of claim 1, wherein the replacing comprises replacing with the second liquid having a lower viscosity than the first liquid.

22. The method of claim 1, wherein the replacing comprises replacing with a silicone oil, glycerol, a paraffinic oil, a naphthenic oil, an aromatic oil, castor oil, or a combination thereof.

23. A method of forming a tunable focal length lens, the method comprising:
forming at least one micro-channel in a polymer matrix;
adding a first liquid to the at least one micro-channel, wherein the first liquid causes a cross-sectional change of the at least one micro-channel, and wherein the cross-sectional change of the at least one micro-channel forms a lens of a first focal length with an aspherical bulge;
bonding the lens to a flexible substrate;
fixing the flexible substrate along with the lens between two rigid spacers; and
applying a first force to the flexible substrate to cause a first change in the first focal length of the lens.

24. The method of claim 23, further comprising applying a second force to the flexible substrate to cause a second change in the first focal length of the lens, wherein the second change in the first focal length is different from the first change in the first focal length.

25. The method of claim 23, further comprising applying uniaxial extensional stress to the polymer matrix after forming the at least one micro-channel in the polymer matrix.

26. The method of claim 23, further comprising applying biaxial extensional stress to the polymer matrix after forming the at least one micro-channel in the polymer matrix.

27. (canceled)

28. The method of claim 23, wherein the adding comprises adding to form the lens having an average thickness of about 15 micrometers to about 85 micrometers.

29.-30. (canceled)

31. The method of claim 23, further comprising one or more of coating the flexible substrate with silane functionalized molecules and oxidizing the flexible substrate with plasma before forming the at least one micro-channel in the polymer matrix.

32.-33. (canceled)

34. The method of claim 23, wherein the forming comprises forming the polymer matrix from polydimethylsiloxane.

35. The method of claim 23, wherein adding comprises adding water, a silicone oil, glycerol, a paraffinic oil, a naphthenic oil, an aromatic oil, castor oil, or a combination thereof.

36. The method of claim 23, wherein the adding comprises adding to form the lens having a first focal length of about 0.25 millimeters to about 0.65 millimeters.

37. The method of claim 23, wherein the adding comprises adding the first liquid having a viscosity of about 100 centipoise to about 1000 centipoise.

38.-67. (canceled)

68. An apparatus comprising:
a reservoir, wherein the reservoir is configured to store at least one liquid;
a device coupled to the reservoir, wherein the device is configured to transfer the at least one liquid from the reservoir; and
a plate with a plurality of micro-channels coupled to the device, wherein the plurality of micro-channels are configured to receive the at least one liquid from the device, wherein the plurality of micro-channels are configured to form at least one lens.

69. The apparatus of claim 68, wherein the plurality of micro-channels has an average diameter of about 0.45 millimeters to about 1.2 millimeters and a thickness of about 15 micrometers to about 85 micrometers.

70.-73. (canceled)

74. The apparatus of claim 68, wherein the at least one liquid is water, a silicone oil, glycerol, a paraffinic oil, a naphthenic oil, an aromatic oil, castor oil, or a combination thereof.

75. The apparatus of claim 68, wherein the at least one lens has a focal length of about 0.25 millimeters to about 0.65 millimeters.

76. (canceled)
